(19) United States
(12) Patent Application Publication
(10) Pub. No.: US 2025/0361184 A1
(43) Pub. Date: Nov. 27, 2025

(54) SELF-REINFORCED ENVIRONMENTAL BARRIER COATINGS

(71) Applicant: OERLIKON METCO (US) INC., Westbury, NY (US)

(72) Inventor: Dianying CHEN, Westbury, NY (US)

(73) Assignee: OERLIKON METCO (US) INC., Westbury, NY (US)

(21) Appl. No.: 18/994,410

(22) PCT Filed: Jul. 26, 2023
(86) PCT No.: PCT/US2023/028685

§ 371 Date: Jan. 14, 2025

Related U.S. Application Data
(60) Provisional application No. 63/398,623, filed on Aug. 17, 2022.

(51) Int. Cl. C04B 35/14; C04B 35/18; C04B 35/80; C04B 41/45; C04B 41/50; C04B 41/52

(52) U.S. Cl. CPC C04B 35/14; C04B 35/18; C04B 35/80; C04B 41/4527; C04B 41/5024; C04B 41/52; C04B 2235/3224; C04B 2235/3463; C04B 2235/80

(57) ABSTRACT

A self-reinforced environmental barrier coating (EBC), methods of manufacturing the EBC, and articles comprising the EBC, are provided. The EBC is prepared from a composition of a rare earth silicate and an aluminum silicate at or near the eutectic point of the combination. The EBC forms a self-reinforcing fibrous phase that reduces or eliminates microcracks.

### CROSS-REFERENCE TO RELATED APPLICATION

This application claims the benefit under 35 U.S.C. § 119(e) of U.S. Provisional Application No. 63/398,623, filed Aug. 17, 2022, the disclosure of which is expressly incorporated by reference herein in its entirety.

### FIELD OF THE INVENTION

The invention relates to compositions and methods of preparation of self-reinforced environmental barrier coatings, and to articles comprising such coatings.

### BACKGROUND OF THE INVENTION

Components of high temperature mechanical systems, such as gas turbine engines, are generally made from materials, such as ceramics ceramic composites, that are resistant to high temperatures. However, such materials may react with some elements and compounds present in the operating environment of high temperature mechanical systems, such as water vapor. Reaction with environmental materials may result in the damage to the component material, and reduce mechanical properties of the component, which may reduce the useful lifetime of the component. Therefore, such components may be coated with an environmental barrier coating (EBC), which may reduce exposure of the substrate to elements and compounds present in the operating environment of high temperature mechanical systems.

Rare earth silicates are known for use in environmental barrier coatings, typically applied over a bond coat. Air plasma spray (APS) processes are often used for the EBC deposition. However, EBCs of rare earth silicates applied by APS are subject to formation of micro-cracks in the as-sprayed APS coatings, which can provide a fast diffusion path for oxidants, and accelerate oxidation of the bond coat (e.g., silicon bond coat), leading to reduced durability of the EBC.

It has been reported to add strengthening fillers to compositions to be prepared into an EBC, e.g., SiC in the form of whiskers and/or nanoparticulates, in order to reduce crack formation (J. Ceramic. Soc. Japan, 129 [4] 209-216, (2021)).

There is a need for rare earth silicate EBCs applied by APS that are less subject to formation of microcracks.

### SUMMARY OF THE INVENTION

A composition is provided comprising a rare earth silicate and aluminum silicate, in a proportion within 20 mol % or 15 mol % of the eutectic point of the composition.

Also provided is an article of manufacture comprising a substrate, a bond coat on the substrate, and an environmental barrier coat (EBC) on the bond coat, wherein the substrate preferably comprises a silicon-based ceramic matrix composite, the bond coat preferably comprises silicon, and the EBC preferably comprises a composition of a rare earth silicate and an aluminum silicate, in a proportion preferably within 20 mol % or 15 mol % of the eutectic point of the composition.

Also provided is a method of manufacturing an environmental barrier coating (EBC) comprising: providing a substrate; applying a bond coat to the substrate; and applying a barrier coat to the bond coat; wherein applying the barrier coat preferably comprises applying a composition comprising a rare earth silicate and aluminum silicate, in a proportion preferably within 20 mol % or 15 mol % of the eutectic point of the composition.

Also provided is a method of manufacturing a reinforcing fibrous phase in a rare earth silicate coating (e.g., an EBC), comprising: obtaining a composition comprising a rare earth silicate and an aluminum silicate in a proportion preferably within 20 mol % or 15 mol % of the eutectic point of the composition; and applying the composition to a substrate to form a rare earth silicate coating; wherein a fibrous phase preferably comprising the rare earth silicate is formed in the rare earth silicate coating. The substrate preferably comprises a SiC ceramic, preferably a bond coat (preferably a silicon bond coat) on a SiC ceramic surface.

The composition is preferably in the form of a sintered powder. The composition is preferably obtained by agglomerating and sintering a mixture of the rare earth silicate and the aluminum silicate.

The rare earth silicate in the composition preferably is Yb₂Si₂O₇. The aluminum silicate in the composition preferably is Al₆Si₂O₁₃. The rare earth silicate in the composition preferably is Yb₂Si₂O₇, and the aluminum silicate in the composition preferably is Al₆Si₂O₁₃.

The proportion of rare earth silicate and aluminum silicate in the composition is preferably within 5 mol % of the eutectic point of the composition.

In an embodiment, the EBC preferably comprises 53 mol % to 83 mol % Yb₂Si₂O₇ with respect to the amount of Yb₂Si₂O₇ and Al₆Si₂O₁₃, more preferably 63 mol % to 73 mol % Yb₂Si₂O₇ with respect to the amount of Yb₂Si₂O₇ and Al₆Si₂O₁₃. Applying the composition to the substrate preferably comprises air plasma spraying.

The EBC preferably comprises a reinforcing fibrous phase.

Also provided is an article comprising an environmental barrier coating made according any of the above methods. The environmental barrier coating made by the methods preferably comprises a reinforcing fibrous phase.

The reinforcing fibrous phase preferably comprises rare earth silicate. The reinforcing fibrous phase preferably comprises Yb₂Si₂O₇.

### BRIEF DESCRIPTION OF THE DRAWINGS

FIG. 1 is a schematic phase diagram of a rare-earth silicate+Al₆Si₂O₁₃ system.

FIGS. 2a and 2b show typical microstructure of agglomerated and sintered Yb₂Si₂O₇—Al₆Si₂O₁₃ composite powder. FIG. 2a is low magnification, and FIG. 2b is high magnification.

FIG. 3 is an air plasma sprayed (APS) Yb₂Si₂O₇ baseline coating showing mud-like micro-cracks.

FIG. 4 is an APS Yb₂Si₂O₇-9 mol % Al₆Si₂O₁₃ baseline coating showing micro-cracks and a few fibers.

FIG. 5 is an APS Yb₂Si₂O₇-17 mol % Al₆Si₂O₁₃ coating showing few micro-cracks and more fiber-like morphologies.

FIG. 6 is an APS Yb₂Si₂O₇-32 mol % Al₆Si₂O₁₃ coating showing fiber-like morphologies with no observed micro-cracks.

FIG. 7 is an APS Yb₂Si₂O₇-60 mol % Al₆Si₂O₁₃ coating showing mud-like micro-cracks.

FIG. 8 is an APS Yb₂Si₂O₇-84 mol % Al₆Si₂O₁₃ coating showing mud-like micro-cracks.

FIG. 9 shows high magnification of APS Yb₂Si₂O₇-32 mol % Al₆Si₂O₁₃ coating showing details of fibers. An EDX analysis (inset) indicates the fiber is composed of Yb₂Si₂O₇ phase.

FIGS. 10a and 10b show growth behavior of thermal grown oxides (TGO) in EBCs. FIGS. 10a (Composition 1) and 10b (Composition 4) are cross sections of aged coatings.

### DETAILED DESCRIPTION OF THE INVENTION

Environmental barrier coatings (EBCs) have been applied onto Si-based ceramic matrix composites (CMCs) for the protection of CMCs from oxidation and water vapor attack. Currently, state of art EBC systems contain a Si bond coat and ytterbium silicate top coat. Air plasma spray (APS) process is generally used for EBC deposition, though other methods are also used. Micro-cracks have always existed in APS ytterbium silicate top coatings. In high temperature gas turbine engine environment, these micro-cracks provide a fast diffusion path for oxidants (water vapor and oxygen) to reach the Si bond coat and accelerate silicon bond coat oxidation. EBCs will spall when the thermally grown oxides (TGO) reach a threshold thickness. Therefore, it is important to develop a tough EBC top coat which could inhibit the micro-cracks formation and therefore increase EBC high temperature durability in water vapor environment.

An EBC top coat composition has been found that that unexpectedly forms self-reinforcing fibers, and exhibits substantially reduced cracking. A material composition and preparation method for self-reinforced composite coating is disclosed. The self-reinforced composite coating materials are composed of rare earth silicate (e.g., Yb₂Si₂O₇) and aluminum silicate (e.g., mullite: Al₆Si₂O₁₃).

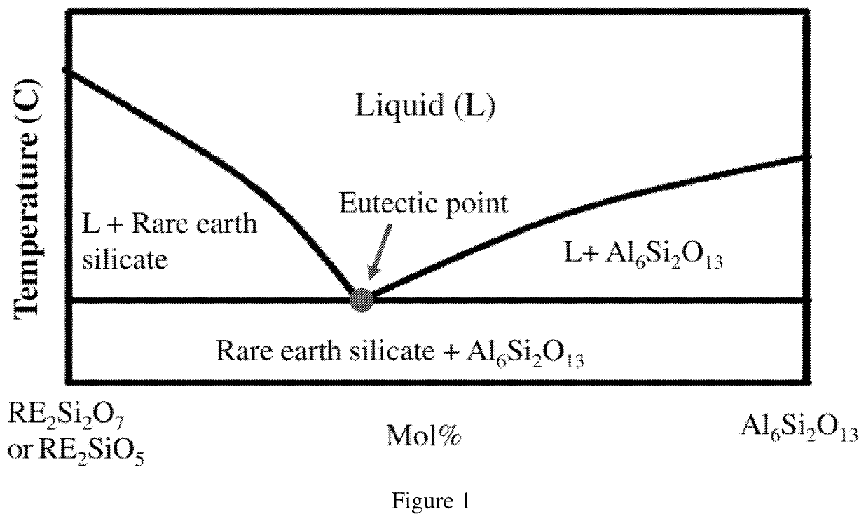

It has unexpectedly been found that compositions of rare earth silicate and aluminum silicate at or near the eutectic temperature (see FIG. 1) form self-reinforced coatings with fibrous portions, and exhibit reduced or no micro-cracks when applied as EBCs. The EBCs substantially reduce or prevent oxidation of the base coat, leading to a more durable EBC. As is known in the art, the eutectic point is an inherent property of a combination of materials.

EBCs prepared from the disclosed composite powders (i.e., aluminum silicate and rare earth silicate) exhibit higher erosion resistance than coatings prepared under the same conditions, but from a baseline composition (i.e., aluminum silicate and no rare earth silicate). Erosion resistance can be measured by methods such as are known in the art, including, e.g., the ASTM G76 specification discussed below. Erosion resistance can be increased by at least 25%, at least 50%, at least 75%, or at least 100% compared to a baseline coating. Although there is no preferred upper limit, it is believed that erosion resistance will generally be increased by 150% or less compared to a baseline coating.

Without being bound by theory, it appears that the reinforcing fibrous phase comprises the rare earth element, primarily in the form of the rare earth silicate. It appears that proximity of the EBC composition to its eutectic point leads to in-situ formation of a rare earth fibrous phase during formation of the environmental barrier coat.

### Composite Powders:

The EBCs composite material comprises any rare earth silicate and aluminum silicate that form a eutectic.

The rare earth silicate can be a mono- or di-silicate, e.g., of formula RE₂Si₂O₇ or RE₂SiO₅, where RE is a rare earth element such as Y, Yb, La, Ce, Pr, Nd, Sm, Eu, Gd, Tb, Dy, Ho, Er, Tm, Lu, preferably Yb.

The content of rare earth silicate can be expressed as mol % of rare earth silicate with respect to the total of rare earth silicate and aluminum silicate. Referring to FIG. 1, a preferred rare earth silicate content is at the eutectic point. The amount of rare earth silicate can be 1 mol %, 5 mol %, 10 mol %, 15 mol %, or 20 mol % lower than the eutectic. The amount of rare earth silicate can be 1 mol %, 5 mol %, 10 mol %, 15 mol %, or 20 mol % higher than the eutectic. Ranges formed by combinations of lower and upper values are contemplated and preferred. For example, some preferred ranges include (but are not limited to), 1 mol % below the eutectic point to 1 mol % above the eutectic point, 1 mol % below the eutectic point to 5 mol % above the eutectic point, 5 mol % below the eutectic point to 1 mol % above the eutectic point, 5 mol % below the eutectic point to 5 mol % above the eutectic point, 5 mol % below the eutectic point to 10 mol % above the eutectic point, 10 mol % below the eutectic point to 5 mol % above the eutectic point, 10 mol % below the eutectic point to 10 mol % above the eutectic point, 10 mol % below the eutectic point to 15 mol % above the eutectic point, 15 mol % below the eutectic point to 10 mol % above the eutectic point, 15 mol % below the eutectic point to 15 mol % above the eutectic point, 20 mol % below the eutectic point to 15 mol % above the eutectic point, 15 mol % below the eutectic point to 20 mol % above the eutectic point, and 20 mol % below the eutectic point to 20 mol % above the eutectic point.

For example, if a rare earth silicate and mullite have a eutectic point at 70 mol % rare earth silicate, some preferred ranges for these components would include (among others) 50-90 mol % rare earth silicate, 50-85 mol % rare earth silicate, 55-80 mol % rare earth silicate, 65-75 mol % rare earth silicate, and 60-75 mol % rare earth silicate. If a recited range includes 1 mol % or 99 mol % rare earth silicate, the corresponding end of the range should be understood to be 1 mol % or 99 mol %, respectively.

Ranges may also be expressed in terms of the eutectic point as follows. EP is defined as the mol % of rare earth silicate (e.g., ytterbium disilicate) at the eutectic point, with respect to the total of rare earth silicate and aluminum silicate (e.g., mullite). EP is an inherent property of the particular rare earth silicate+aluminum silicate combination. Some preferred ranges include from (EP-20 mol %) to (EP+20 mol %), from (EP-15 mol %) to (EP+15 mol %), from (EP-10 mol %) to (EP+10 mol %), from (EP-5 mol %) to (EP+5 mol %), from (EP-1 mol %) to (EP+1 mol %), from (EP-5 mol %) to (EP+1 mol %), and from (EP-1 mol %) to (EP+5 mol %). These may also be expressed as within 20 mol % of the eutectic point, 15 mol % of the eutectic point, within 10 mol % of the eutectic point, within 5 mol % of the eutectic point, and within 1 mol % of the eutectic point.

A proportion of ytterbium disilicate should be used for the in-situ growth of Yb₂Si₂O₇ fibers in the coating. Ytterbium disilicate and mullite are believed to have a eutectic point at about 68 mol % ytterbium disilicate. Some preferred ranges for these components include 48-58 mol % ytterbium disilicate, 53-83 mol % ytterbium disilicate, 58-78 mol % ytterbium disilicate, and 58-73 mol % ytterbium disilicate. Other preferred ranges include of Yb₂Si₂O₇ in Yb₂Si₂O₇—Al₆Si₂O₁₃ composites include 57 mol % to 83 mol %; 63-73 mol %; and 67-69 mol %.

Composite powders preferably consist of rare earth silicate and aluminum silicate, aside from impurities (such as Na2O, TiO2, CaO, MgO etc.). Impurities can comprise less than 0.5 wt %.

Composite powders may also comprise a strengthening filler (e.g., nanoparticulates and/or whiskers of, e.g., SiC). If present, a composite powder preferably comprises 20 wt % or less, 15 wt % or less, 10 wt % or less, 5 wt %, of strengthening filler with respect to the total weight of rare earth silicate, aluminum silicate, and strengthening filler. Preferably, the composite powder comprises no (0 wt %) strengthening filler.

### Manufacture of Composite Powders:

Composite powders according to the present disclosure can be made by any suitable method by a person of skill in the art. Some suitable methods include:
blending
agglomerating
agglomerating and sintering; and
fusing and crushing.

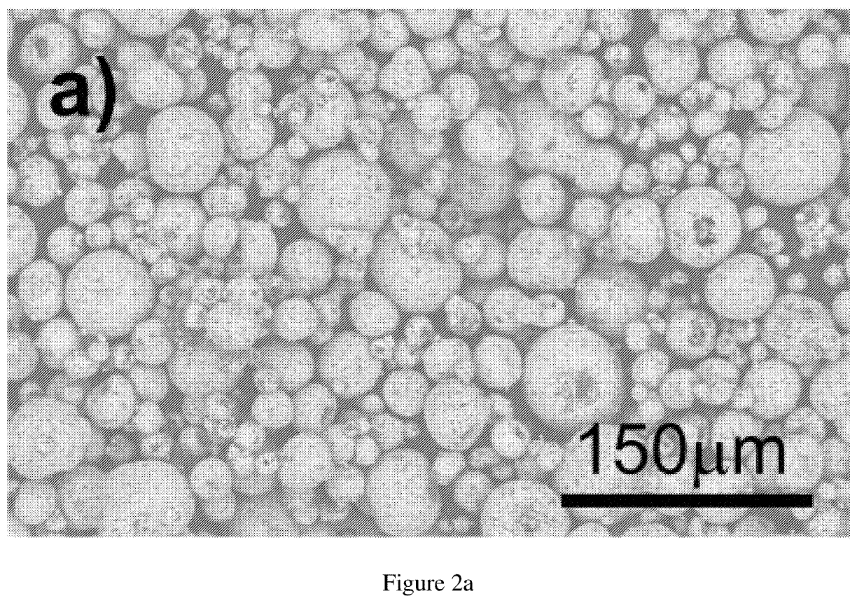

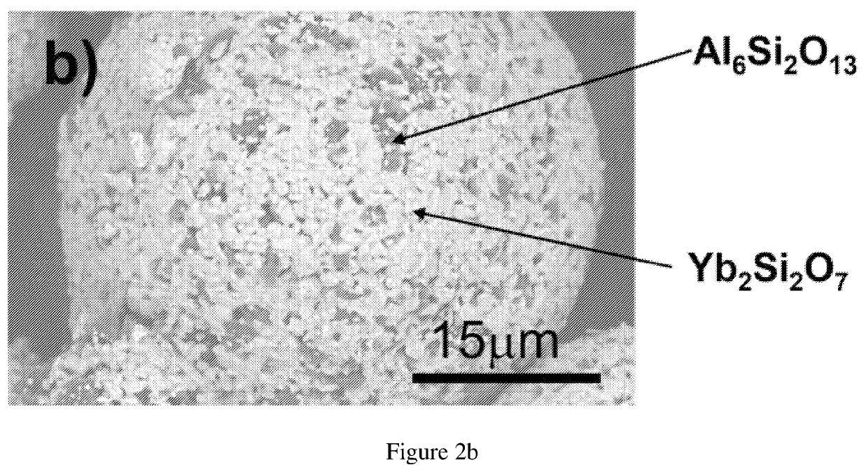

Agglomerating and sintering is a preferred method. FIGS. 2a and 2b show typical microstructure of an agglomerated and sintered Yb₂Si₂O₇—Al₆Si₂O₁₃ composite powder.

Any particle size distribution for the compositions that is suitable for the powder manufacturing method and the coating formation method, and can be determined by one of skill in the art. The typical particle size distribution, e.g., of Yb₂Si₂O₇ (YbDS)-Al₆Si₂O₁₃ composite powders, can be 5 μm, 10 μm, 11 μm, 20 μm, 30 μm or 40 μm, or larger, and can be 150 μm, 105 μm, 100 μm, 90 μm, 70 μm, 62 μm, or 60 μm or smaller. Ranges formed from pairs of these smaller and larger sizes are included. Some preferred ranges include, e.g., 40 μm to 60 μm, 11 μm to 105 μm, 11 μm to 62 μm, 5 μm to 150 μm, 10 μm to 150 μm, 10 μm to 100 μm, 20 μm to 90 μm, and 30 μm to 70 μm.

### Manufacturing Coatings:

Any method of applying an EBC can be used as determined by a person of skill in the art. Some suitable methods include:
air plasma spray (APS);
high velocity oxy-fuel spray (HVOF);
combustion spray;
vacuum plasma spray (VPS); and
suspension thermal spray.

An EBC is preferably applied by APS. The parameters for APS coating can be determined by a person of skill in the art. Some representative process parameters include:
Current: 200-800 A;
Voltage: 50-150 V;
Power: 10-120 kW;
Ar flow: 50-100 nlpm
H₂ flow: 1-10 nlpm
Powder feeding rate: 1-100 g/min
Spray distance: 50-250 mm

Any method of applying a bond coat (e.g., silicon) to a substrate can be used as determined by a person of skill in the art, including thermal spray processes, such as APS, VPS, HVOF, combustion spray, and suspension thermal spray. APS is preferred.

It is believed that a small amount of rare earth aluminate reaction product, such as Yb₃Al₅O₁₂ may form in-situ during formation of the EBC. If present, it is believed the amount formed in the EBC would be less than 3 mol % based on the total of rare earth silicate, aluminum silicate, and rare earth aluminate reaction product.

### EXAMPLES

### Example 1

Six batches of agglomerated and sintered were made with various ratios of Yb₂Si₂O₇ and Al₆Si₂O₁₃ as shown in Table 1. For the preparation of composite powders, Yb₂Si₂O₇ and Al₆Si₂O₁₃ powders were mixed in a water based slurry and spray dried to form agglomerated spherical powders. The spherical powders were then sintered at 1,300° C. and then the sintered powders were screened to −62+11 μm.

TABLE 1

| | Yb₂Si₂O₇ (mol %) | Al₆Si₂O₁₃ (mol %) |
|---|---|---|
| Composition 1 | 100 | 0 |
| Composition 2 | 91 | 9 |
| Composition 3 | 83 | 17 |
| Composition 4 | 68 | 32 |
| Composition 5 | 40 | 60 |
| Composition 6 | 16 | 84 |

Coatings were applied to SiC ceramic surfaces as follows. For each of compositions 1-6, a Si bond coat was applied to the SiC ceramic surface using APS. The corresponding Composition was then applied over the Si bond coat using APS. The APS process parameters are shown in Table 2.

TABLE 2

| | Si | Yb₂Si₂O₇-x mol % |
|---|---|---|
| | Bond Coat | Al₆Si₂O₁₃ Top Coat |
| Current A | 450 | 500 |
| Voltage V | 96.6 | 97 |
| Power kW | 43.5 | 48.5 |
| Ar nlpm | 75 | 70 |
| H₂ nlpm | 5 | 5 |
| Powder feeding rate g/min | 20 | 20 |
| Spray distance (mm) | 150 | 150 |

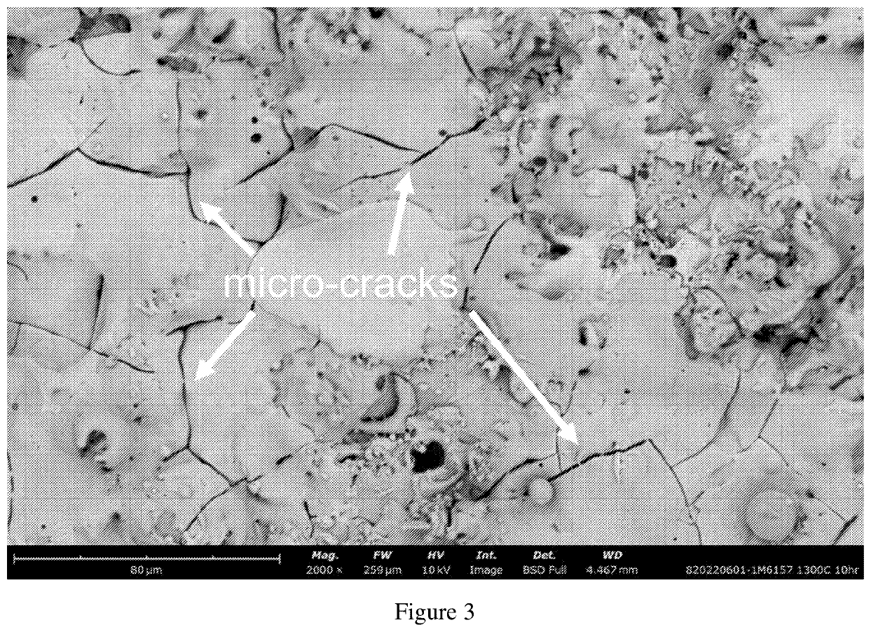

SEM images of the APS coating surfaces prepared from Compositions 1-6 are shown in FIGS. 3 to 8, respectively.

Composition 1, a comparative example of a baseline Yb₂Si₂O₇ coating without aluminum silicate (FIG. 3), showed a significant number of micro-cracks.

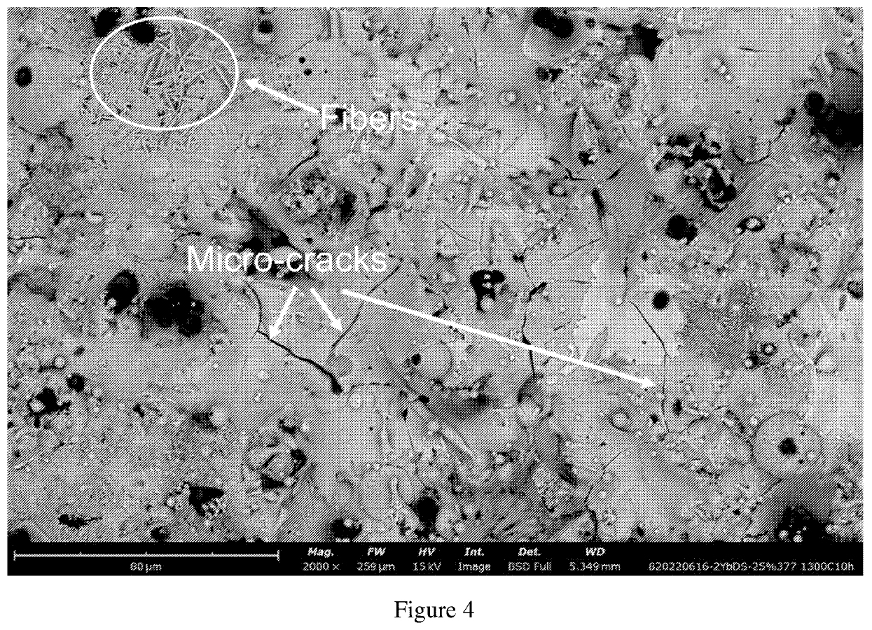

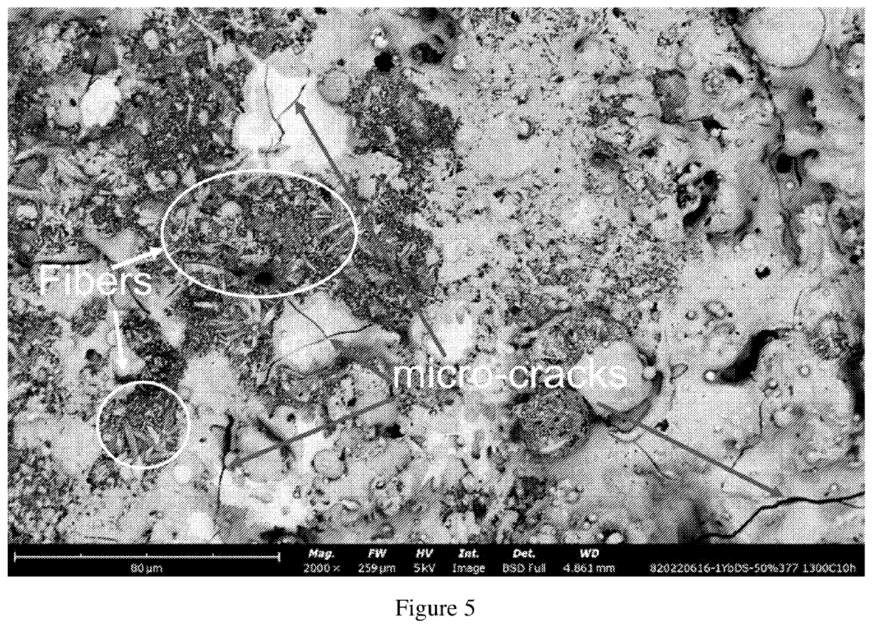

As the molar percentage of Al₆Si₂O₁₃ increased (FIGS. 4 and 5) in the Yb₂Si₂O₇—Al₆Si₂O₁₃ composite coatings, the number of micro-cracks decreased, while more fiber-like morphology appeared.

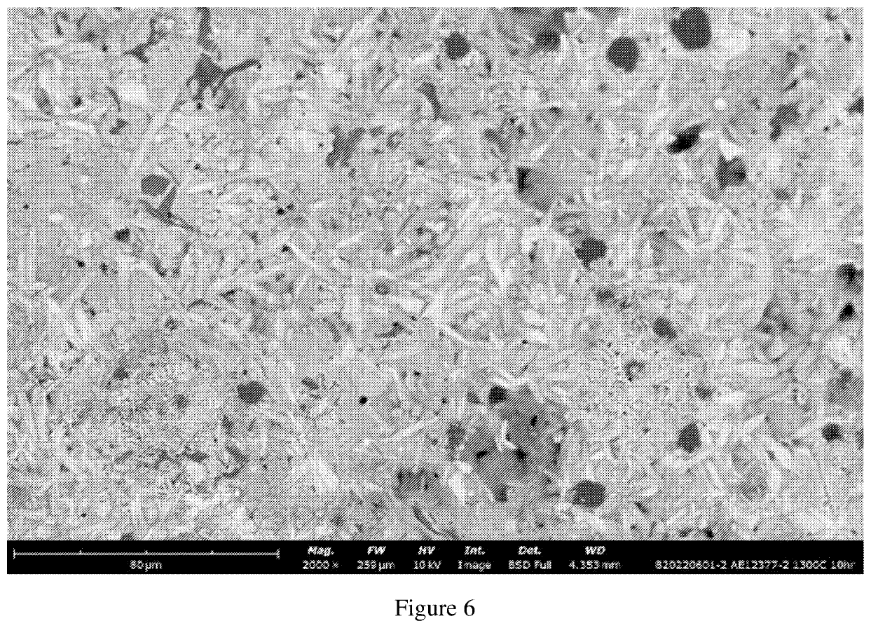

No microcracks were observed in the Yb₂Si₂O₇-32 mol % Al₆Si₂O₁₃ composite coatings (FIG. 6).

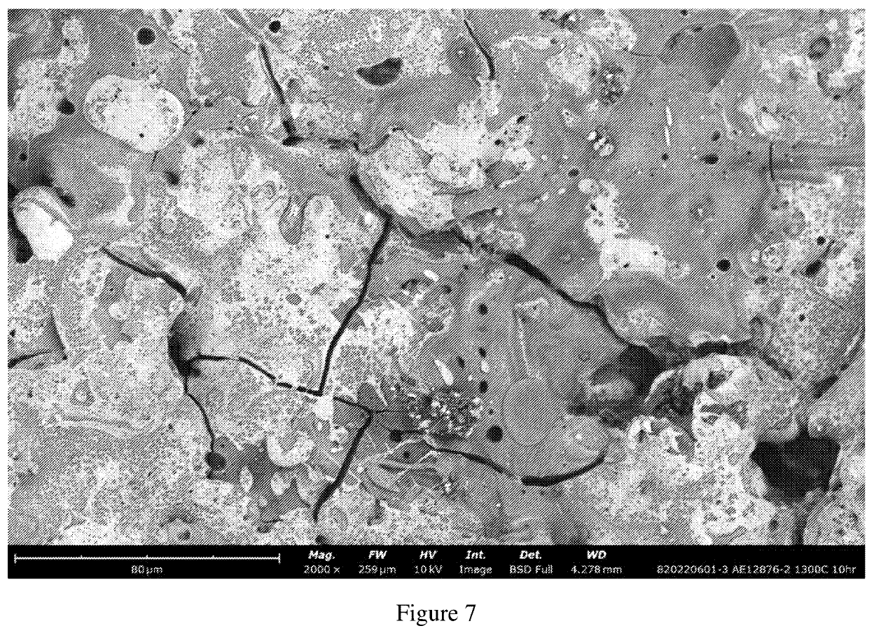

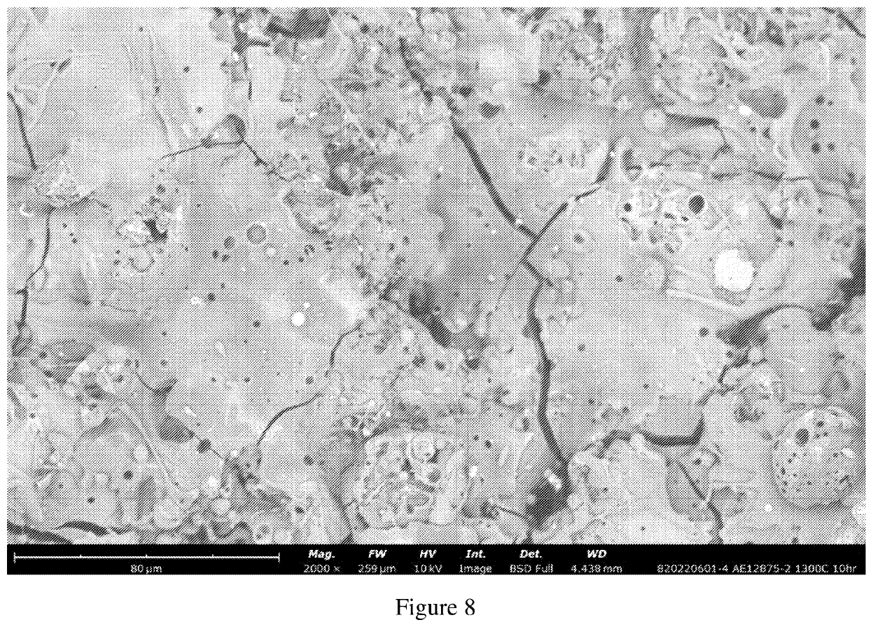

As the molar percentage of Al₆Si₂O₁₃ was further increased, the fiber-like morphology decreased, and the coatings began to exhibit more micro-cracks (FIGS. 7 and 8).

The results indicate the optimum Al₆Si₂O₁₃ in the Yb₂Si₂O₇—Al₆Si₂O₁₃ composite is approximately 32 mol % for a micro-crack free coating with fiber-like morphology (FIG. 6).

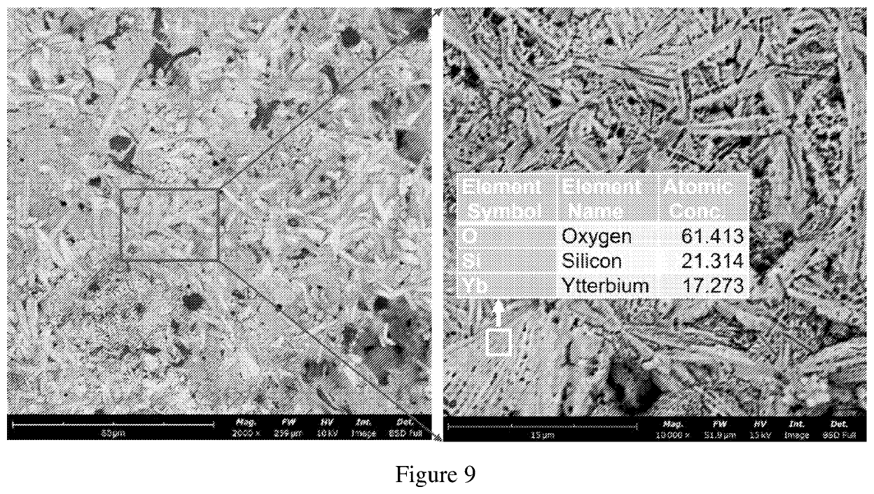

High magnification photomicrographs of a Yb₂Si₂O₇-32 mol % Al₆Si₂O₁₃ composite coating are shown in FIG. 9. Elemental analysis of a fibrous portion of the EBC indicates that it comprises ytterbium, primarily in the Yb₂Si₂O₇ phase.

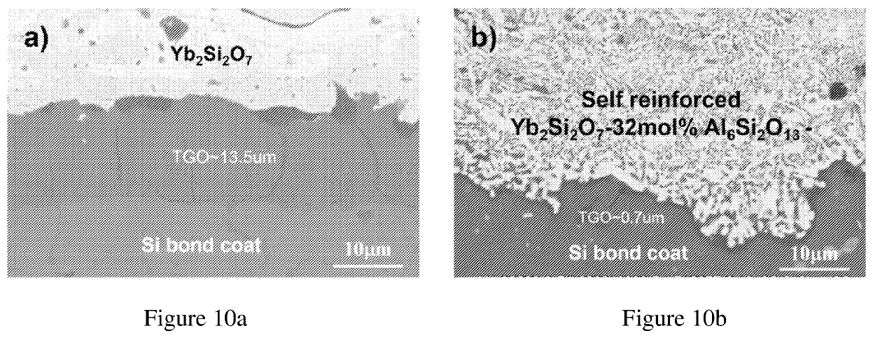

Protective abilities of Compositions 1 and 4 were compared as follows. Silicon bond coatings were applied to two SiC ceramic surfaces as described above. One surface was then APS coated as described above with an EBC of comparative Composition 1, and the other with an EBC of Composition 4. The coated surfaces were then exposed to an environment of 90 vol % H₂O-10 vol % air at 1,316° C. for 510 hours. Cross section photomicrographs are shown in FIG. 10a (Composition 1) and FIG. 10b (Composition 4).

FIG. 10a shows growth of thermally grown oxide (TGO) of about 13.5 μm in thickness. FIG. 10b shows TGO growth of about 0.7 μm in thickness, about one-twentieth the amount of the control sample. It appears that TGO growth in self-reinforced Yb₂Si₂O₇-32 mol % Al₆Si₂O₁₃ on Si bond coat is about 20 times slower that in baseline Yb₂Si₂O₇ on Si bond coat.

### Example 2

EBCs prepared from Composition 1 (baseline) and Composition 4, were prepared as in Example 1, and were tested for hardness and erosion resistance.

Rockwell hardness was measured using the method of HR15N.

Erosion resistance of the coatings was measured using an erosion test rig according to the ASTM G76 specification. In particular, an aluminum oxide powder with particle sizes in the range of 40-80 μm is used as the erodent. The erodent was accelerated at room temperature onto the EBC surface at an angle of 20° until a specific dose of approximately 600 g had been delivered. The depth of the eroded crater was then measured. The erosion resistance is expressed in seconds/mil and represents the time needed to erode 1 mil of the coating thickness. A higher erosion resistance number means better erosion resistance.

Results are shown in Table 3.

TABLE 3

| | Erosion resistance | Hardness |
|---|---|---|
| EBC Coating | [sec/mil] | HR15N |
| Composition 1 | 10.9 | 84.6 |
| Composition 4 | 19.8 | 88.0 |

The fiber like coating prepared from Composition 4, having the self-reinforced microstructure, exhibited about double the erosion resistance compared to the non-self-reinforced baseline EBC coating prepared from Composition 1. In addition, due to the crack-free microstructure, the self-reinforced coating hardness was also slightly improved compared to baseline.

1.-7. (canceled)

8. An article of manufacture comprising a substrate, a bond coat on the substrate, and an environmental barrier coat (EBC) on the bond coat, wherein
the substrate comprises a silicon-based ceramic matrix composite,
the bond coat comprises silicon, and
the EBC comprises a composition of a rare earth silicate and an aluminum silicate, in a proportion within 20 mol % of the eutectic point of the composition, and comprises a reinforcing fibrous phase comprising the rare earth silicate.

9. The article of claim 8 wherein the rare earth silicate is Yb₂Si₂O₇, and the aluminum silicate is Al₆Si₂O₁₃.

10. The article of claim 9 wherein the proportion is within 5 mol % of the eutectic point of the composition.

11. The article of claim 9, wherein the EBC comprises 53 mol % to 83 mol % Yb₂Si₂O₇ with respect to the amount of Yb₂Si₂O₇ and Al₆Si₂O₁₃.

12. The article of claim 10, wherein the EBC comprises 63 mol % to 73 mol % Yb₂Si₂O₇ with respect to the amount of Yb₂Si₂O₇ and Al₆Si₂O₁₃.

13.-14. (canceled)

15. A method of manufacturing an environmental barrier coating comprising:
providing a substrate;
applying a bond coat to the substrate; and
applying a barrier coat to the bond coat;
wherein applying the barrier coat comprises applying a composition comprising a rare earth silicate and aluminum silicate, in a proportion within 20 mol % of the eutectic point of the composition,
wherein the environmental barrier coating comprises a fibrous phase comprising the rare earth silicate.

16. The method of claim 15, wherein applying the composition comprises air plasma spraying.

17. The method of claim 15, wherein the composition is obtained by agglomerating and sintering a mixture of the rare earth silicate and aluminum silicate.

18. The method of claim 15, wherein the rare earth silicate is Yb₂Si₂O₇, the aluminum silicate is Al₆Si₂O₁₃, and the composition comprises 63 mol % to 73 mol % Yb₂Si₂O₇ with respect to the amount of Yb₂Si₂O₇ and Al₆Si₂O₁₃.

19. An article comprising an environmental barrier coating made according to claim 15.

20. (canceled)

21. An article comprising an environmental barrier coating made according to claim 18.

22.-32. (canceled)

33. The article of manufacture of claim 8, wherein the proportion is within 15 mol % of the eutectic point of the composition.

34. The method of manufacturing an environmental barrier coating of claim 15, wherein the proportion is within 15 mol % of the eutectic point of the composition.

35. (canceled)

36. The article of manufacture of claim 8, wherein the EBC has an erosion resistance at least 25% higher than a second EBC prepared similarly, but without any rare earth silicate.

37. The method of manufacturing an environmental barrier coating of claim 15, the barrier coat has an erosion resistance at least 25% higher than a second barrier coat prepared similarly, but without any rare earth silicate.

38.-41. (canceled)
